(19) United States
(12) Patent Application Publication
(10) Pub. No.: US 2020/0370527 A1
(43) Pub. Date: Nov. 26, 2020

(54) ELECTRICALLY CRANKED ENGINE SYSTEMS

(71) Applicant: ZYLUX DISTRIBUTION PTY LTD, MELBOURNE (AU)

(72) Inventor: TROY STURTEVENT, MELBOURNE (AU)

(21) Appl. No.: 16/417,740

(22) Filed: May 21, 2019

(51) Int. Cl. F02N 11/08; F02N 11/14

(52) U.S. Cl. CPC F02N 11/0803; F02N 11/0862; F02N 11/14

(57) ABSTRACT

An electrically cranked internal combustion engines, and particularly an internal combustion engine cranked using an electrical starter connected to a storage battery.

### BENEFIT OF PRIOR FILINGS

The present application is a first filing, having no benefit of a prior filing date.

### FIELD

This invention is directed to electrically cranked internal combustion engines, and particularly an internal combustion engine cranked using an electrical starter connected to a storage battery. Exemplary internal combustion engines include petrol or diesel internal combustion engines such as those found in an automobile, boat, motorcycle, recreational vehicle, or an electricity generator.

### PRIOR ART

Internal combustion engines are typically cranked (i.e. turned and started) with an electric starter motor meshed to the engine flywheel. The starter is typically powered by an associated storage battery. Once the internal combustion engine has started, an electrical generator in meshed arrangement with the engine recharges the battery to replace the stored electrical energy given up by the battery in initially cranking the engine.

As is well known, all storage batteries have a finite life beyond which their usefulness in efficiently cranking an internal combustion engine is significantly diminished. The service life of a battery may be compromised by a parasitic drain due to the use of ancillary devices drawing current form the battery which also supplies the starter. For example, the electrical circuits of modern vehicles comprise sound systems, USB charging outlets, navigation systems, video screens, and parking assistance systems each of which draws current. In some circumstances, current may be drawn even when the engine is not running

Another source of parasitic load in modern vehicles is caused by fuel conservation systems which automatically shut down the internal combustion engine when a vehicle is braked and restart the internal combustion engine when the brake is released. Whilst these systems are effective in saving fuel, the economy may be false given the shortened service life of the battery.

Apart from parasitic loads, the operating conditions under which a storage battery may operate can shorten service life. For example, a vehicle battery may be exposed to freezing conditions in colder climates, but then must endure elevated temperatures in the engine bay given the close proximity to the exhaust manifold. Vibrations transmitted from a vehicle chassis may also negatively affect the service life of a battery.

Irrespective of the cause leading up to the failure of a cranking battery, it is typical for some signs to foreshadow the impending demise of the battery. For example, an internal combustion engine may need to be cranked for an extended period, or multiple attempts at cranking may be required. Many users ignore these signs and at some point the battery becomes is sufficiently depleted that the internal combustion engine simply does not start. Where the battery is in a vehicle, the driver becomes stranded and must seek assistance to start the engine, and later to install a replacement battery.

Systems and devices to address the problems discussed above as provided in the art. For example, the art provides a range of jump starting devices and supplementary power source technologies that may be used to start an engine under conditions of battery failure. While such approaches may be s short-term solution, they do nothing to extend the service life a cranking battery. supplementary power source

### SUMMARY

In a first aspect the present invention provides a system for augmenting the power output of a battery configured to power a starter motor of an internal combustion engine, the system comprising a supplementary power source, the system configured to form an electrical connection between the supplementary power source and the starter motor before, at the time of, or within 1000 ms of starter motor actuation so as to augment the power output of the battery thereby limiting the current drawn from the battery when powering the starter motor.

In one embodiment of the first aspect, the system is configured to form an electrical connection between the supplementary power source and the starter motor within 400 ms, 100 ms, or 10 ms of starter motor actuation.

In one embodiment of the first aspect, the system is configured such that power output of the battery is augmented by at least about 10% by the supplementary power source during starter motor operation as compared with the situation where no supplementary power source is provided.

In one embodiment of the first aspect, the system is configured such that power output of the battery is augmented by at least about 20%, 30% or 40% during starter motor operation as compared with the situation where no supplementary power source is provided.

In one embodiment of the first aspect, the system is configured such that the current drawn from the primary battery during starter motor operation is decreased by at least about 10% as compared with the situation where no supplementary power source is provided.

In one embodiment of the first aspect, the system is configured such that the current drawn from the primary battery during starter motor operation is decreased by at least about 20% or 30% as compared with the situation where no supplementary power source is provided.

In one embodiment of the first aspect, the system comprises a detector configured to detect starter motor actuation.

In one embodiment of the first aspect, the detector detects any one or more of: a voltage drop in a circuit connecting the battery to the starter motor, a current in a circuit connecting the battery to the starter motor, closure of a circuit connecting the battery to the starter motor, or actuation of a switch configured to close a circuit connecting the battery to the starter motor.

In one embodiment of the first aspect, the system comprises a voltage sensor configured to sense the voltage of the battery before actuation of the starter motor, wherein the system is configured such that where the sensed voltage is relatively low and therefore indicative of potential difficulty in cranking the internal combustion engine, the system is configured to connect the supplementary power source to the starter motor.

In one embodiment of the first aspect, the system comprises a switch being operable so as to connect and disconnect the supplementary power source to and from the starter motor.

In one embodiment of the first aspect, the system comprises a detector configured to detect starter motor actuation wherein the detector is in operable communication with the switch such that when the detector outputs a signal indicative of starter motor actuation the switch connects the supplementary power source to the starter motor.

In one embodiment of the first aspect, the system comprises a voltage sensor configured to sense the voltage of the battery before actuation of the starter motor, wherein where the sensed voltage is relatively low and therefore indicative of potential difficulty in cranking the internal combustion engine, the switch connects the supplementary power source to the starter motor.

In one embodiment of the first aspect, the system comprises a microprocessor configured to detector starter motor actuation and rapidly cause connection of the supplementary power supply to the starter motor.

In one embodiment of the first aspect, the system comprises a detector configured to detect starter motor actuation and/or a voltage sensor wherein the processor is configured to accept the output of the detector and/or the voltage sensor, and furthermore where indicated by the output of the detector and/or voltage sensor output a signal causing the rapid connection of the supplementary power supply to the starter motor.

In one embodiment of the first aspect, the system comprises a remote switch allow a user to manually cause connection of the supplementary power source to the starter motor, and a user-comprehensible indicator of the battery condition.

In one embodiment of the first aspect, the indicator is a visual indication being on or proximal to the remote switch.

In one embodiment of the first aspect, the battery condition is battery voltage or is derived from battery voltage.

In a second aspect, the present invention provides a method for augmenting the power output of a battery configured to power a starter motor of an internal combustion engine, the method comprising the step of connecting a supplementary power source to the starter motor before, at the time of, or within 1000 ms of starter motor actuation so as to augment the power output of a battery used to power the starter motor thereby limiting the current drawn from the battery when powering the starter motor.

In one embodiment of the second aspect, the method comprises the step of connecting the supplementary power source to the starter motor within 400 ms, 100 ms or 10 ms of starter motor actuation.

In one embodiment of the second aspect, the method comprises the step of a user assessing the state of the battery and causing the connection of the supplementary power source to the starter motor where the state of the battery is indicative of the need for augmentation of the power output of the battery.

### DETAILED DESCRIPTION OF THE INVENTION

The present invention is predicated at least in part of the finding that a supplementary power source (such as a secondary battery, including a supercapacitor) which can be connected and/or isolated in a controllable manner from an electrical starting circuit of an internal combustion engine provides advantage in the art. Accordingly, in a first aspect the present invention provides a system for augmenting the power output of a battery configured to power a starter motor of an internal combustion engine, the system comprising a supplementary power source, the system configured to form an electrical connection between the supplementary power source and the starter motor before, at the time of, or within 1000 ms of starter motor actuation so as to augment the power output of the battery thereby limiting the current drawn from the battery when powering the starter motor.

As used herein, the term “battery” is intended to be construed broadly to include a substantially portable power source including a battery of any chemistry (such as lead acid, lithium ion, lithium air, lithium titanate, alkaline, nickel metal halide, zinc air, zinc carbon, zinc chloride and the like). The term “battery” may also include substantially portable energy storage means which holds static charge (as distinct from an electrochemical cell), such as a super capacitor.

Typically the battery is a storage battery. Where multiple batteries are used in the system, the batteries may be different types of battery. Where the system is installed in machine having a primary internal combustion engine starting battery, the supplementary power source may the same or different to that of the primary internal combustion engine starting battery. Given the benefit of the present specification, the skilled person will be enabled to select an appropriate battery for a required application.

The supplementary power source and the detector will generally be electrical and/or electronic in nature (and in some circumstances having a mechanical component) however other means deemed suitable by the skilled person are contemplated to be useful. The supplementary power source may be a battery (and in some cases will be a supercapacitor).

Where a battery is rechargeable, it is generally recharged by connection to a generator that is turned by the internal combustion engine.

This detailed description is directed to the use of the present system as fitted to an automobile. This is a typical application of the system, however it will be appreciated that other applications will provide advantage and utility.

In an automobile, the primary internal combustion engine starting battery is the main 12 volt battery which powers the starter circuit, and indeed all other electrical components of the vehicle. It will be understood that the primary internal combustion engine starting battery is typically not a component of the system, but this possibility is not excluded.

The system may be configured such that the supplementary power source is connectable to the internal combustion engine starting circuit. The configuration also allows for the supplementary power source to be isolated from the charging circuit. The connection/isolation may also apply to the other circuits of the internal combustion engine or other circuits of the machine to which the system is fitted. Such other circuits include a battery charging circuit, or an accessory circuit.

In one embodiment, the system is configured such that the supplementary power source is connectable to the primary vehicle starting battery. The supplementary power source may be connected to the primary internal combustion engine starting battery in series or parallel, although typical a parallel connection is used. Means for making an electrical connection to a battery are well known to the skilled person and include the use of an appropriate gauge wire (rated according to expected amperage) with electrical terminals such as a battery clamp.

In some circumstances, the supplementary power source may be attached indirectly to the primary internal combustion engine starting battery. For example, many vehicles are wired with the chassis in electrical connection to the negative terminal of the primary internal combustion engine starting battery. In that circumstance the negative terminal of the supplementary power source may be configured to be connectable to the vehicle chassis.

A switch may be provided in the system which functions so as to allow for the selective connection and isolation of the supplementary power source to and from the internal combustion engine starting circuit. The switch may be processor-controlled providing significant advantage as will be apparent from the following description.

The system may be configured such that at the time of starting the internal combustion engine the supplementary power source is connected to the internal combustion engine starting circuit such that the supplementary power source acts to assist the primary internal combustion engine starting battery during cranking of the internal combustion engine. However, once the internal combustion engine has been successfully started (i.e. once the internal combustion engine is turning over without the assistance of the starter) the supplementary power source is isolated from the internal combustion engine starting circuit so as to avoid further drain on that battery during driving. Thus, the supplementary power source is spared the current drain caused by headlights, electrical accessories of the vehicle, or a stop-start internal combustion engine ignition system. In particular, with stop-start internal combustion engine systems when the internal combustion engine has been stopped (to conserve fuel, whilst stationary at traffic lights, for example) the charging circuit of the vehicle is not operational and so significant advantage is gained in isolating the supplementary power source from current draining circuits of the vehicle.

Typically, isolation of the supplementary power source will prevent charging of the supplementary power source during driving. Accordingly, in some embodiments the system is configured such that the supplementary power source is connected to the charging circuit of the automobile for at least some time so as to increase the charge level of the supplementary power source. For example, where the supplementary power source is connected in parallel with the primary internal combustion engine starting battery, the supplementary power source is connected to both the internal combustion engine starting circuit and the charging circuit. Accordingly, after starting the internal combustion engine the supplementary power source may remain connected to the primary internal combustion engine starting battery until the charge in the supplementary power source is replenished at which point the switch acts to isolate the supplementary power source.

The switch may utilize any suitable means for achieving electrical connection or isolation, including switching means such as electromechanical switching means (a relay being exemplary) or transistor switching means (such as a metal-oxide-semiconductor field-effect transistor). Preferably, the connection/isolation means is controllable by an integrated circuit (such as an electronic control unit) so as to allow for automatic or semi-automatic connection and isolation of the supplementary power source.

Advantageously, by the selective connection and isolation of the supplementary power source the supplementary power source may be spared excessive drain during driving (such as due to a stop-start system), and maintained in a useful condition for an extended period of time. Thus, the primary internal combustion engine starting battery will typically fail before the supplementary power source, and therefore the supplementary power source will generally be able to assist starting when the primary internal combustion engine starting battery is incapable of delivering sufficient power to the starter to effectively crank the internal combustion engine. Of course, at some point the supplementary power source will also fail however by that stage the driver is likely to have noticed dysfunction of the primary internal combustion engine starting battery and have had that battery replaced. In some embodiments, the system is configured so as to warn the driver that the supplementary power source is assisting the primary internal combustion engine starting battery, such as by way of a warning light or sound when the switch connects the supplementary power source to the internal combustion engine starting circuit. In this way, the driver is never stranded by a depleted primary internal combustion engine starting battery.

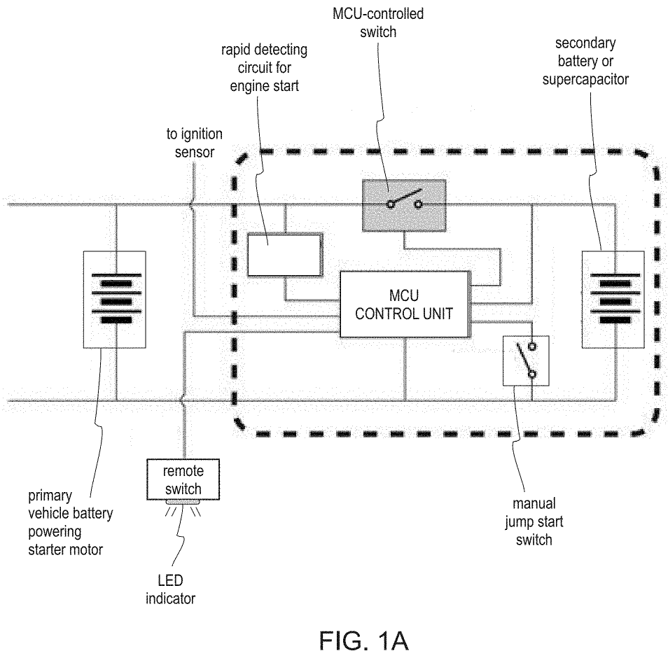

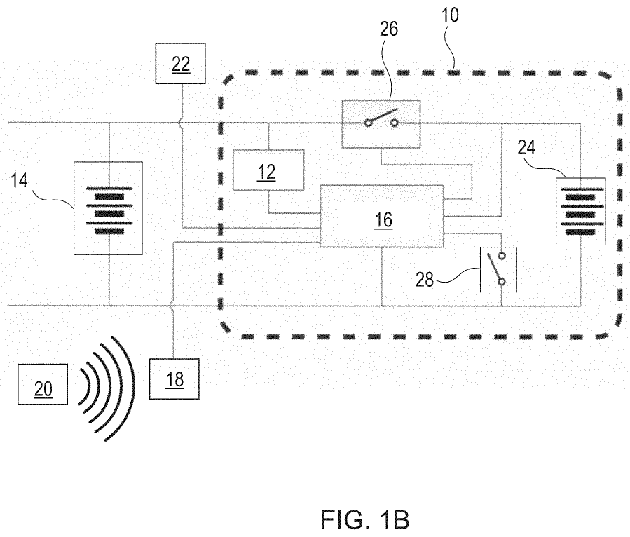

In one embodiment, the system is configured such that the switch is configured to rapidly connect the supplementary power source to the internal combustion engine starting circuit upon starting the automobile. Applicant proposes that practical advantage is gained where starting assistance is provided by the supplementary power source with no delay, or with minimal delay. The very deep discharge of a primary internal combustion engine starting battery immediately upon starting may cause premature failure of that battery. Typically, a maximum current of around 700 Amp is immediately drawn by the starter, with the current quickly dropping to around 200-400 Amps before the internal combustion engine starts and the starter ceases to draw current. Reference is made to FIG. 1 which shows the normal internal combustion engine starting current over time. Instituting starting assistance during the initial peak current draw results in the primary internal combustion engine starting battery being supported by the supplementary power source at the most critical time.

As will be appreciated, stop-start vehicle internal combustion engines subject the primary internal combustion engine starting battery to multiple instances of deep discharge in the course of a single trip. Applicant has recognized this problem, and proposes the present system as a solution.

Applicant has recognized the further problem that where the assistance of a supplementary power source is required then that battery must be connected very rapidly to the primary internal combustion engine starting battery so as fully avoid (or substantially avoid) the very deep discharge of the primary battery which occurs within the first hundreds of milliseconds upon the initiation of internal combustion engine starting.

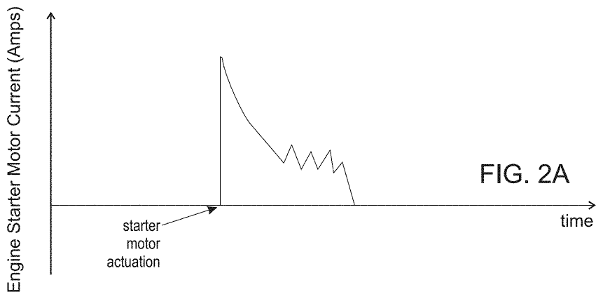

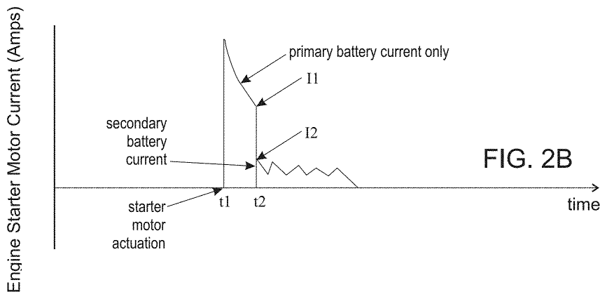

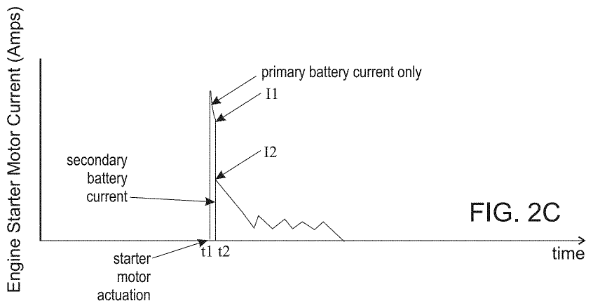

Reference is made to FIG. 2 showing internal combustion engine starting current over time where the supplementary power source provides starting assistance at around the 400 ms point. Initiation of internal combustion engine starting is marked on the X-axis “t1” with the connection of the supplementary power source marked “t2” (t2−t1=400 ms). It will be noted that some assistance is provided toward the end of the initial peak, with the Applicant finding that some advantage in battery life or performance is provided.

Applicant has further recognized from FIGS. 1 and 2 that significant deterioration in battery life or performance is still effected by the initial current drawn as shown in FIG. 2, and that further improvement is possible by further shortening the delay between the points t1 and t2.

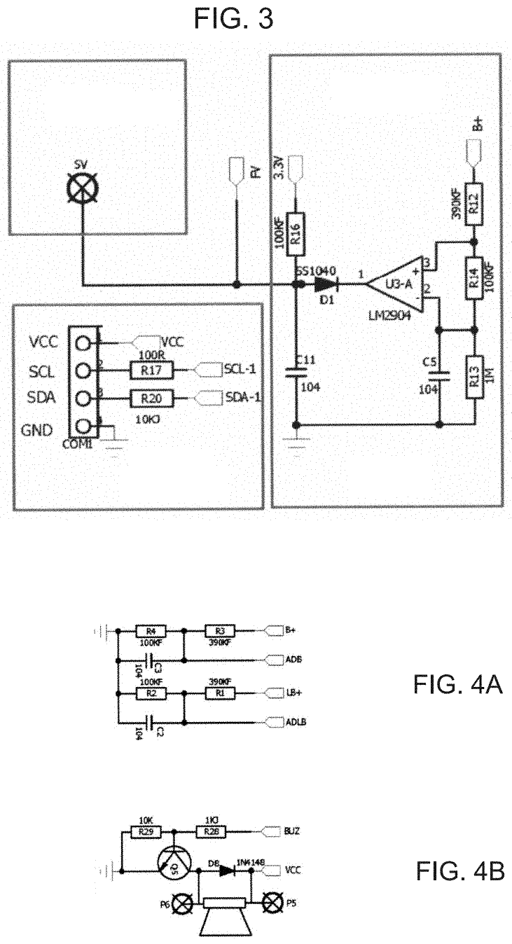

Reference is made to FIG. 3 showing internal combustion engine starting current over time where the supplementary power source provides starting assistance at around the 10 ms point. It will be noted that assistance is provided almost immediately (t2−t1=10 ms), with this providing greater advantage than the situation shown in FIG. 2. In particular, it can be seen that the initial deep discharge of the battery is substantially avoided where the supplementary power source is connected virtually instantaneously after initiation of internal combustion engine starting. Comparing the points marked “I1” and “I2” across FIGS. 2B and 2C demonstrates that decreasing the delay in providing supplementary power source assistance provides increased current at points I1 and I2, leading to better performance (often noted in more rapid starting of the internal combustion engine) and greater avoidance of deep discharge of the primary internal combustion engine starting battery leading to shortening the serviceable life of the primary internal combustion engine starting battery.

For stop-start internal combustion engines, rapid automatic starting of the internal combustion engine whilst in traffic has practical importance. For example, it may be necessary for a driver stopped in traffic to rapidly accelerate so as to avoid another vehicle. Even for regular internal combustion engines, rapid starting provides advantage by avoiding wear on the start motor, and associated gearing, and also the internal combustion engine fly wheel.

Incremental advantage is gained with each incremental decrease in the delay in providing supplementary power source assistance. Accordingly, each incremental decrease in delay below about 400 ms is significant with respect to an increase in advantage.

In one embodiment the present system comprises means for rapidly detecting initiation of internal combustion engine starting. Rapid detection minimizes the delay in activation of the switch, so as to in turn assure rapid connection of the supplementary power source to the primary internal combustion engine starting battery.

The rapid internal combustion engine starting detection means may comprise or consist of circuitry configured to detect an electrical event that occurs in the course of starting an internal combustion engine. The electrical event may be a drop in voltage of the primary internal combustion engine starting battery, or an increase in current flow through the internal combustion engine starting circuit for example. Other suitable events will be immediately apparent to the skilled person having the benefit of the present specification.

The system may be configured such that the supplementary power source is connected to the internal combustion engine starting circuit only when the primary internal combustion engine starting battery requires assistance. The requirement for assistance may be detected by a detector configured to sense the state of the primary internal combustion engine starting battery. For example, the detector may sense the voltage of the primary internal combustion engine starting battery and where less than a certain threshold (for example 12.2 V) trigger the switch configured to connect the supplementary power source to the internal combustion engine starting circuit.

In another embodiment, the need for assistance is detected by sensing any one or more of: slow internal combustion engine cranking, extended internal combustion engine cranking, failure of the internal combustion engine to start within a predetermined time, or current flow in the charging circuit during starting less than a predetermined value.

In one embodiment, the second detector starting is configured to receive a signal (and even a simple “on” signal) from the driver-actuated ignition switch. In this embodiment, there is no requirement for the detection of any electrical event in the internal combustion engine starting circuit. In some embodiments, there may be no delay in providing supplementary power source assistance because the supplementary power source is connected to the primary internal combustion engine starting battery at the initiation of internal combustion engine starting or even slightly before the initiation of internal combustion engine starting. Vehicles having key-barrel ignition switches must typically be turned to a first position to delivery current to accessory circuits, before being turned to a second position which actually initiations vehicle starting be connection of the starter to the primary battery. In such a circumstance, the system is configured to connect the second battery when the ignition is turned to the first position such that the supplementary power source is already assisting the primary battery when the starter commences internal combustion engine cranking.

In some embodiments, the system does not comprise any internal combustion engine starting detection means and instead relies on the driver (whether actively or passively) triggering the connection of the supplementary power source to the internal combustion engine starting circuit. In these embodiments, the connection may be made seconds, or tens of seconds before the internal combustion engine is started by the driver. An advantage of maintaining the supplementary power source in an isolated state until just before the internal combustion engine is started is that inadvertent current drain from the secondary batter is avoided by, for example, an interior light being left on overnight. In such a circumstance, the primary internal combustion engine starting battery may be discharged, while the supplementary power source is preserved.

The active means may be a driver-actuatable dedicated device, such as a simple switch disposed on the dashboard.

Alternatively, the active means may be configured such that the driver is able to consciously or unconsciously actuate a non-dedicated device of the vehicle such as a door switch, a seatbelt engagement switch, a clutch pedal switch, a pressure switch in the driver's seat, a brake pedal switch, a throttle position sensor, a gear selector sensor, or a door handle switch.

In some cases, a switch is not used. For example, the insertion of an electronic starting key into a reader port in the dash, and the successful reading of the correct code may trigger connection of the supplementary power source to the primary internal combustion engine starting battery. This occurs prior to the initiation of internal combustion engine starting which is typically effected by the driver manually pressing a button on the dash.

In another form, the system is configured to be operable by active means by use of a device which is actuatable by the driver when remote from the automobile. For example, a remote RF vehicle locking and unlocking means (of the type which is original equipment in many vehicles) may trigger connection of the supplementary power source to the internal combustion engine starting circuit when the driver is approaching the vehicle and unlocks the door.

Alternatively, a dedicated remote device may be provided to specifically trigger the connection. As one example of this embodiment the system may comprise a Bluetooth™ module such that by app-assisted means the user may use a smart phone or similar device to actively trigger connection of the supplementary power source to the internal combustion engine starting circuit.

With regard to passive means for triggering connection, one example includes the use of an RFID tag and reader system. The RFID tag may be attached to the driver's keys, with the system comprising a RFID receiver which detects when the tag is approaching. Proximity of the RFID tag is detected by the receiver which in turn sends a positive signal to an electronic control unit which in turn connects the supplementary power source to internal combustion engine starting circuit by way of the switch.

Another passive means may rely on a user smart phone having Bluetooth™ communicability. Thus, when a Bluetooth™ module of the system detects proximity of the driver's smart phone (which is continuously transmitting an identification signal), the module sends a positive signal to an electronic control unit which in turn connects the supplementary power source to internal combustion engine starting circuit by way of the switch. It will be preferred to program the electronic control unit to respond only to the driver's smart phone and no other smart phone. This may be achieved by the need to “pair” the smart phone during set up of the system. Where required, pairing of the smart phone of secondary driver(s) may be provided for.

In one embodiment of the invention, the system comprises a user actuatable switch, or means to receive the output of a user actuatable switch configured to connect the supplementary power source to the internal combustion engine starting circuit. The function of this switch is to compel the driver to take an active step to connect the supplementary power source in the event that the primary internal combustion engine starting battery is in a depleted state and due for replacement. In the absence of any need for active input from the driver, the driver is more likely to ignore or not notice any explicit or implicit warning that the primary internal combustion engine starting battery should be replaced. The switch may be a dedicated switch or a switch already present in the vehicle (such as a brake pedal switch) or a switch associated with the vehicle (such as a key fob switch).

Preferably, the switch is positioned so as to cause some inconvenience to the driver when actuating. In this way, the user is less likely to simply actuate the switch with little thought and effort, and greater attention will be given to replacing the battery. For example, the switch may be positioned in the internal combustion engine bay such that the bonnet of the vehicle must be lifted so as to actuate the switch. This action will impress upon the driver the potential need for roadside assistance if the battery is not replaced.

In some embodiments there is provided an indicator on or about the driver actuatable switch having an indicator thereon, the indicator providing an indication of the battery state to the driver. Reference is made to the embodiment of FIG. 1A in that regard. The battery state may be voltage, although the indicator does not necessary need to display a numerical voltage or any other indication of voltage level. Instead, the indicator may simply have an “off” state (reflecting that the voltage is acceptable) and an “on” state (reflecting that voltage is unacceptably low). However indicated, where voltage is unacceptably low the user may actuate the switch so as to connect the supplementary power source to the primary vehicle battery before starting the vehicle engine. In this way, the primary battery is assisted immediately upon actuation of the starter motor thereby facilitating engine starting. In the absence of such assistance, the primary battery may be deeply discharged (which is damaging to the battery), and the vehicle may not even start.

In some embodiments, the indicator is disposed proximal to the switch, the distance between the two being less than about 10 cm, 9 cm, 8 cm, 7 cm, 6 cm, 5 cm, 4 cm, 3 cm, 2 cm or 1 cm. When looking at the indicator, the driver's eye is also drawn toward the switch such that where the indicator indicates a poor battery state the driver is not required to scan the vehicle controls for the switch. The proximity of the switch to the indicator ensures that no time is wasted searching for the switch.

It is not necessary for the indicator to be visual. The indicator may be audible. For example, the driver actuatable switch may have a small piezo buzzer embedded therein, with an aperture in the switch face to allow soundwaves to pass outwardly. An unacceptable battery state may cause a sound to be emitted from the switch, thereby drawing the driver's attention to the location of the switch, and prompting the driver to actuate the switch. The sound source may be disposed proximal to the switch, the distance between the two being less than about 10 cm, 9 cm, 8 cm, 7 cm, 6 cm, 5 cm, 4 cm, 3 cm, 2 cm or 1 cm such that the driver's attention is nevertheless drawn toward the switch when a sound is emitted.

The driver actuatable switch may place the system into jump starting mode (as described more fully infra) such that the vehicle primary battery does not contribute current during starting, with all starting current being derived from the secondary power source. Alternatively, the switch may cause the secondary power source to provide starting current additional to the primary vehicle battery.

If the main battery is heavily discharged (for example, the voltage is less than 5.0V or fully discharged), the switch may be configured so as to provide a manual jump start by connecting the supplementary power source to the internal combustion engine starting circuit.

The present system may be configured so as to be capable of being retrofitted to an existing machine, such as an automobile, a motorcycle, a boat, a quad bike, a scooter, or a generator. In such circumstances, the system may consist of a robust housing to safely contain the electronics, and shield sensitive parts from heat, cold, water, vibration, contaminants and the like. Electrical conduit may extending through ports of the housing, and configured with terminals so as to form electrical connections with the machine's battery, internal combustion engine starting circuit, switches, sender units, sensors, internal combustion engine management unit, and the like. Any active electronics of the system (such as a Bluetooth™ module) may be powered by the primary internal combustion engine starting battery so as to avoid depletion of the supplementary power source.

Accordingly, the present invention includes within its scope methods for fitting a system of the present invention to a machine. Preferably the machine is an automobile and more preferably an automobile having a stop-start ignition system.

In some embodiments, the system will simply connect to the terminals of the primary internal combustion engine starting battery, and indeed may be configured to be secured to the primary battery.

It is contemplated that the system may be integral with a primary internal combustion engine starting battery, with the electronics and the supplementary power source being contained within battery casing.

The system is typically configured as a jump starter or an emergency jump starter or battery bank of the type familiar to the skilled artisan, and also familiar to consumers of such products. Generally, the system in such configurations is substantially self-contained and often with indicia and/or status LEDs visible on an outer rigid casing.

In another form, the system may also be integral with a machine, and may include components which are normally present in the machine such as wiring, switches, electronic control units, secondary batteries, and the like. In a preferred embodiment, the system in integral with an automobile, and particularly an automobile with a stop-start ignition system.

### ILLUSTRATIVE EMBODIMENTS OF THE INVENTION

The present invention will now be more fully described by reference to the following non-limiting examples. The present invention will now be more fully described by reference to the following illustrative embodiments.

FIG. 1A shows a schematic block diagram of a preferred battery assistance system of the present invention comprising a secondary battery, a processor, a detector configured to rapidly detect starter motor operation and a manual switch having an LED battery condition indicator. The system is shown installed into the starting circuit of a vehicle having a primary battery.

FIG. 1B is a schematic block diagram of a system similar to that shown in FIG. 1A, except having a wireless remote switch that is actuatable by a user.

FIG. 2 shows comparative graphs detailing current flow in a vehicle starting circuit for a vehicle not fitted with the present system (FIG. 2A), a vehicle fitted with the present system capable of providing supplementary power source assistance within about 400 ms of starting (FIG. 2B), and a vehicle fitted with the present system capable of providing supplementary power source assistance within about 400 ms of starting (FIG. 2C).

FIG. 3 shows schematics of the three means for use in triggering the connection of the supplementary power source to the primary internal combustion engine starting battery is a circuit diagram.

FIG. 4A shows a schematic of voltage detecting circuitry to detect the primary battery voltage and the supplementary power source voltage by control unit.

FIG. 4B shows a schematic of primary battery low-voltage alarm circuitry.

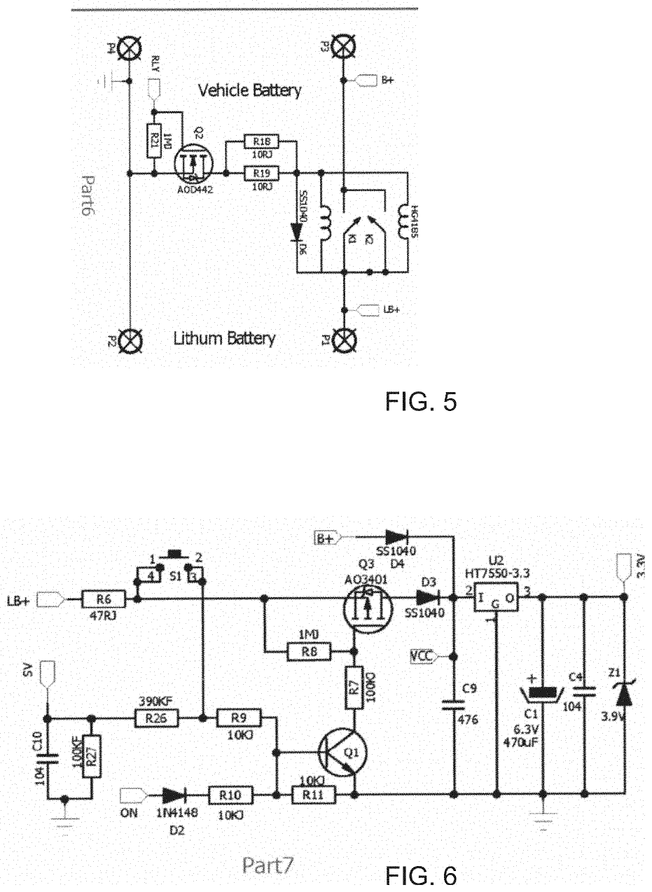

FIG. 5 shows a schematic of charge and discharge current circuitry.

FIG. 6 shows a schematic of power supply circuitry and emergency jump start circuitry.

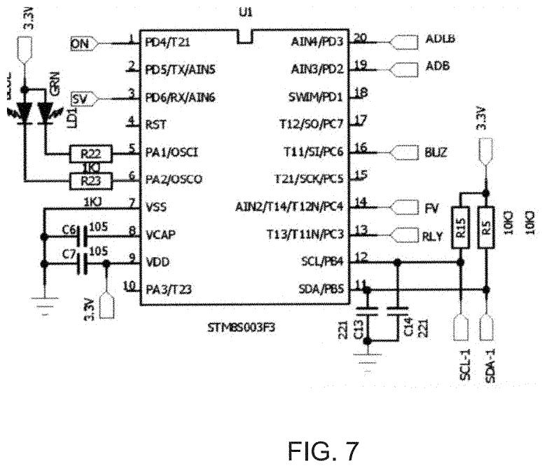

FIG. 7 shows microchip control unit and LED indication circuitry, control unit is in charge of the entire system and LED is to indicate the working condition.

One preferred embodiment comprises a supplementary power source and internal combustion engine start rapid detection circuitry for use in a vehicle. Reference is made to FIG. 1B showing one possible installation scheme. The system is contained within a housing 10 containing a module 12 which rapidly detects internal combustion engine starting according to a significant voltage drop across the terminals of the primary internal combustion engine starting battery 14. The detection circuitry module 12 is connected across the primary battery 14 via the electronic control unit 16. Also connected to the control unit 16 is a receiver module 18 configured to receive a wireless signal transmitted from a remote device 20. The vehicle ignition switch 22 is also connected to the control unit 16. Thus, the control unit can receive a positive signal form any one or more of the remote device 20, the ignition switch 22 or the detection circuitry module 12. The supplementary power source 24 is a lithium ion battery capable of effectively cranking the vehicle internal combustion engine, and connected in parallel to the primary battery via the controllable switch 26. In the drawing, the switch is shown in the open position such that the supplementary power source 24 is isolated from the primary battery 14. The controllable switch 26 is actuated by the control unit 16 to be alterable from the open state to the closed state thereby alternately isolating and connecting the supplementary power source 24. The System further comprises a manual jump start switch 28 which is also connected to the control unit 16. Actuation of the jump start switch 28 at any time sends a signal to the control unit 16, the control unit 16 in turn causing the controllable switch 26 to close thereby connecting the supplementary power source 24 to the primary battery 14, and therefore the internal combustion engine starting circuit.

While the vehicle internal combustion engine is starting (and the starter is cranking the internal combustion engine), the voltage of main battery will rapidly drop, and the rapid detection module 12 will detect this voltage variation and then send a positive signal to the control unit 16.

In addition, the control unit 16 is capable of continuously sensing the primary battery 14 voltage and the supplementary power source 24 voltage. Where the control unit 16 detects the primary battery 14 voltage less than a certain value, for example, less than 12.2V, the control unit will alter the driver by way of buzzer (not shown). If the control unit 16 detects the supplementary power source 24 is less than a certain value, for example, less than 10.0V, and further detects whether the internal combustion engine is running (for example by checking for a current or voltage from the vehicle generator), and where the internal combustion engine is running and the supplementary power source 24 voltage is less than 10.0V, the supplementary power source 24 will be automatically connected to the primary battery 14 in parallel and accept the charging current from the main battery.

An alternative to the embodiment of FIG. 1B is that shown in FIG. 1A being distinguished by the use of remote hard wired switch which is typically disposed in the cabin of a vehicle and therefore easily accessible by a driver. The switch has an LED indicator light thereon which is instructed by the MCU to become lit when the battery voltage is less than a predetermined acceptable value. Further discussion on the operation of embodiments having an indicator on or proximal to a switch is provided supra.

FIG. 3 shows schematics of the three means for use in triggering the connection of the supplementary power source to the primary internal combustion engine starting battery. As included in the boxed area 100, the port of SV is the signal input port of ignition, when the internal combustion engine starts, the internal combustion engine will send a signal to SV port, and then transfer it to control unit to rapidly actuate control unit, and then rapidly connect the supplementary power source to the primary battery.

Alternatively (as shown in the boxed area marked 200), the port of COM1 is the interface of the remote receiver; it consists of four ports with VCC, SCL, SDA, GND, when the remote signal is received, it is transferred to control unit through this interface to rapidly actuate control unit, and then rapidly connect the supplementary power source to the primary battery.

Alternatively (as shown in the boxed area marked 300) there is shown internal combustion engine start detection circuitry comprising operational amplifier U3, resistor R12-R14, capacitor C5, C11, diode D1, resistor R16. This circuitry functions to rapidly detect changes in the main battery voltage. When the internal combustion engine starts, the voltage of main battery drops, the voltage of the positive polarity of the primary battery (B+) is divided by resistor R12, R14, R13 and filtered by capacitor C5 and then transferred to the Pin 2 and Pin 3 of U3. U3 is an operational amplifier, the voltage of Pin2 is higher than the voltage of Pin3, the pin 1 of U3 will output a low voltage signal, and then send it to Pin14 (FV pin) of control unit through the diode D1, and then rapidly connect the supplementary power source to the primary battery.

Turning now to FIG. 4A there is shown voltage detecting circuitry, consisting of resistor R1-4, capacitor C2-3, which is to detect the primary battery voltage and the supplementary power source voltage by control unit. When the primary battery voltage is less than 12.2V, the voltage of B+ is divided by the resistor R3 and R4 and filtered by capacitor C3 and then transferred to Pin 19 (ADB pin) of control unit U1, control unit determines if the primary battery is under-voltage, and controls the buzzer shown in FIG. 4B. When the voltage of supplementary power source in is less than 10V, the voltage of LB+ is divided by resistor R1, R2 and filtered by capacitor C2 and then transferred to Pin 20 (ADLB pin) of control unit U1, control unit determines the supplementary power source is under-voltage, and then control the circuitry in FIG. 5 to cause charging of the supplementary power source.

Turning to FIG. 4B there is shown schematic of a primary battery low-voltage alarm circuitry, consisting of transistor Q5, resistor R28, R29, diode D8, buzzer P5-6. When control unit detects the main battery voltage less than 12.2V via the voltage detecting circuit of FIG. 4A, the Pin 14 (BUZ pin) of control unit outputs a driving pulse, through R28 and R29, and then turn on Q5, after that, Q5 will turn on P5-6 buzzer to alarm and indicate the main battery is under charge.

Turning to FIG. 5 there is shown charge and discharge current circuitry consisting of MOSFET Q2, Resistor R18, R19, diode D6, and Relay K1-2. When the internal combustion engine starts, control unit is rapidly actuated by the circuitry of FIG. 3, the pin 13 (RLY pin) of control unit outputs a driving voltage to the gate of MOSFET Q2, turn on Q2; the primary battery B+ is through the coil of relay K1 and K2, and R18, R19, Q2 DS to the ground, when the coil of K1 and K2 is closed, the supplementary power source (LB+) will be connected to the primary battery (B+) in parallel through the coil K1 and K2, thereby rapidly start the internal combustion engine with the supplementary power source and primary battery connected in parallel. On the other hand, when the supplementary power source is less than 10V, the pin 13 (RLY) of control unit outputs a driving voltage to the gate of Q2, then Q2 is turned on, the primary battery (B+) is through the coil of Relay K1 and K2, R18, R19, Q2 DS to the ground, the coil of K1 and K2 is closed, the primary battery (B+) is connected to the supplementary power source (LB+) in parallel to realize the primary battery to charge the seconding battery automatically when the internal combustion engine is running.

FIG. 6 shows the power supply circuitry and emergency jump start circuitry, consisting of the resistor R6, manual jump start switch S1, diode D2-4, MOSFET Q3, voltage stabilized chip U2, zener diode Z1, capacitor C9-10, C1, C4, resistor R7-11, transistor Q1, resistor R26-27. When the system is connected, the primary battery (B+) is isolated by D4, filtered by C9, and then stabilized the voltage by U2, and further filtered by C1 and C4, outputs a stabilized voltage of 3.3V, thereby supply to pin 9 of control unit. If the main battery voltage is less than 5V or OV, and the internal combustion engine cannot start, then user presses the jump start switch S1, the supplementary power source (LB+) will turn on the transistor Q1 after R6, S1, R9 and R11; and then Q1 will turn on the MOSFET Q3 through R7 and R8, the supplementary power source (LB+) is through R6, S1, Q3 and isolated by D3, filtered by C9, stabilize the voltage by U2, further filtered by C1 and C4, supply a stabilized voltage of 3.3V to pin 9 (Vdd) of control unit. In the meantime, the supplementary power source voltage (LB+) is through R6, S1, divided by R26 and R27, filtered by 010, send it to pin 3 (SV pin) of control unit, control unit determines it is at emergency state, and then control unit pin 1 (ON pin) and outputs a driving voltage, this driving voltage makes the transistor Q1 turn on after D2 and R10, further, lock up the status of Q1 turning on, also, the pin 13 (RLY pin) of control unit outputs a driving voltage to the gate of Q2, and Q2 is turned on, the primary battery (B+) is through the relay coil K1 and K2, R18, R19, Q2 DS to the ground, K1 and K2 will be closed, and supplementary power source (LB+) is connected to the primary battery (B+) in parallel through the coil of K1 and K2, thereby the supplementary power source is independently to start the internal combustion engine at this condition. In FIG. 6, alternatively, the Relay K1 and K2 can be MOSFETs control switch.

FIG. 7 shows microchip control unit and LED indication circuitry, control unit is in charge of the entire system and LED is to indicate the working condition. The stabilized voltage of 3.3V supplied to pin 9 of control unit from the circuitry of FIG. 6, the capacitor C6 and C7 is wave filtered capacitor, R5 and R15 is the pull-up resistor for control unit communication ports, C13 and C14 is the anti-interference capacitor. When the battery assist starts, the pin 5 of control unit will output a low voltage, the voltage of 3.3V is through LED LD1, resistor R22, control unit pin 5, the green LED LD1 turns on, indicating the battery assist is in the working status and supplementary power source is delivering output current. When the supplementary power source is accepting the charging current, the pin 6 of control unit outputs a low voltage signal, the voltage of 3.3V is through LED LD2, resistor R23, control unit pin 6, the blue LED LD2 turns on, indicating that the supplementary power source is automatically accepting the charging current.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following are hereby expressly incorporated into this description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

In the description provided herein, numerous specific details are set forth. However, it is understood that embodiments of the invention may be practiced without these specific details. In other instances, well-known methods, structures and techniques have not been shown in detail in order not to obscure an understanding of this description.

In the following claims, any of the claimed embodiments can be used in any combination.

1. A system for augmenting the power output of a battery configured to power a starter motor of an internal combustion engine, the system comprising a supplementary power source, the system configured to form an electrical connection between the supplementary power source and the starter motor before, at the time of, or within 1000 ms of starter motor actuation so as to augment the power output of the battery thereby limiting the current drawn from the battery when powering the starter motor.

2. The system of claim 1, configured to form an electrical connection between the supplementary power source and the starter motor within 400 ms, 100 ms, or 10 ms of starter motor actuation.

3. The system of claim 1, configured such that power output of the battery is augmented by at least about 10% by the supplementary power source during starter motor operation as compared with the situation where no supplementary power source is provided.

4. The system of claim 3, configured such that power output of the battery is augmented by at least about 20%, 30% or 40% during starter motor operation as compared with the situation where no supplementary power source is provided.

5. The system of claim 1, configured such that the current drawn from the primary battery during starter motor operation is decreased by at least about 10% as compared with the situation where no supplementary power source is provided.

6. The system of claim 5, configured such that the current drawn from the primary battery during starter motor operation is decreased by at least about 20% or 30% as compared with the situation where no supplementary power source is provided.

7. The system of claim 1 comprising a detector configured to detect starter motor actuation.

8. The system of claim 7, wherein the detector detects any one or more of: a voltage drop in a circuit connecting the battery to the starter motor, a current in a circuit connecting the battery to the starter motor, closure of a circuit connecting the battery to the starter motor, or actuation of a switch configured to close a circuit connecting the battery to the starter motor.

9. The system of claim 1 comprising a voltage sensor configured to sense the voltage of the battery before actuation of the starter motor, wherein the system is configured such that where the sensed voltage is relatively low and therefore indicative of potential difficulty in cranking the internal combustion engine, the system is configured to connect the supplementary power source to the starter motor.

10. The system of claim 9, comprising a switch being operable so as to connect and disconnect the supplementary power source to and from the starter motor.

11. The system of claim 10, comprising a detector configured to detect starter motor actuation wherein the detector is in operable communication with the switch such that when the detector outputs a signal indicative of starter motor actuation the switch connects the supplementary power source to the starter motor.

12. The system of claim 10 comprising a voltage sensor configured to sense the voltage of the battery before actuation of the starter motor, wherein where the sensed voltage is relatively low and therefore indicative of potential difficulty in cranking the internal combustion engine, the switch connects the supplementary power source to the starter motor.

13. The system of claim 1, comprising a microprocessor configured to detector starter motor actuation and rapidly cause connection of the supplementary power supply to the starter motor.

14. The system of claim 13, comprising a detector configured to detect starter motor actuation and/or a voltage sensor wherein the processor is configured to accept the output of the detector and/or the voltage sensor, and furthermore where indicated by the output of the detector and/or voltage sensor output a signal causing the rapid connection of the supplementary power supply to the starter motor.

15. The system of claim 1 comprising:
a remote switch allow a user to manually cause connection of the supplementary power source to the starter motor, and
a user-comprehensible indicator of the battery condition.

16. The system of claim 13, wherein the indicator is a visual indication being on or proximal to the remote switch.

17. The system of claim 13, wherein the battery condition is battery voltage or is derived from battery voltage.

18. A method for augmenting the power output of a battery configured to power a starter motor of an internal combustion engine, the method comprising the step of connecting a supplementary power source to the starter motor before, at the time of, or within 1000 ms of starter motor actuation so as to augment the power output of a battery used to power the starter motor thereby limiting the current drawn from the battery when powering the starter motor.

19. The method of claim 18, comprising the step of connecting the supplementary power source to the starter motor within 400 ms, 100 ms or 10 ms of starter motor actuation.

20. The method of claim 18, comprising the step of a user assessing the state of the battery and causing the connection of the supplementary power source to the starter motor where the state of the battery is indicative of the need for augmentation of the power output of the battery.
